(19) United States
(12) Patent Application Publication
(10) Pub. No.: US 2011/0217931 A1
(43) Pub. Date: Sep. 8, 2011

(54) SIMULATION TESTING SYSTEM FOR A MOBILE COMMUNICATION APPARATUS AND SIMULATION TESTING METHOD THEREOF

(75) Inventor: HAO-LIANG ZHOU, Nanjing (CN)

(73) Assignees: INVENTEC APPLIANCES (SHANGHAI) CO. LTD., Shanghai (CN); INVENTEC APPLIANCES CORP., Taipei County (TW); INVENTEC APPLIANCES CORP., NANJING, Nanjing (CN)

(21) Appl. No.: 12/951,328

(22) Filed: Nov. 22, 2010

(30) Foreign Application Priority Data
Mar. 3, 2010 (CN) 201010118415.0

(51) Int. Cl. H04W 24/06; H04B 7/00

(52) U.S. Cl. 455/41.2; 455/67.14

(57) ABSTRACT

A simulation testing system for a mobile communication apparatus and a simulation testing method thereof are disclosed. The simulation testing system comprises a first mobile communication device and a second mobile communication device. The first mobile communication device comprises a first command processing module and a data processing module. The first command processing module sends an attention command. The second mobile communication device comprises a second command processing module, having a simulation unit for receiving the attention command and simulating a modulator/demodulator to transmit a simulation connection command. After the first mobile communication device receives the simulation connection command, the data processing module sends the testing data to the second mobile communication device. Compared with previous testing system of a mobile communication apparatus, the simulation testing system does not need a network. Therefore, the development of video phone would be more smoothly than before.

### FIELD OF THE INVENTION

The exemplary embodiment(s) of the present invention relates to a simulation testing system and a simulation testing method thereof. More specifically, the exemplary embodiment(s) of the present invention relates to a simulation testing system for a mobile communication apparatus and a simulation testing method thereof.

### BACKGROUND OF THE INVENTION

With continuous development of third-generation (3G) mobile communication, more and more mobile phone companies invest large people and resources to research and develop 3G mobile phones. With regard to 3G mobile phones, the development of video telephones is one of the most important functions in 3G mobile telephone. However, 3G network coverage rate of many places is not good enough. The pre-development for video telephones may be influenced.

Please refer to FIG. 1, FIG. 2 and FIG. 3. FIG. 1 is a schematic diagram for a first command sending module sending an attention command, and FIG. 2 is a schematic diagram for a modulator/demodulator (modem) sending a connection command, and FIG. 3 is a schematic diagram for a data sending module sending testing data to a receiving mobile communication device via networks. When the testing staff tests the mobile communication device, the testing staff utilizes the testing system 100. The testing system 100 comprises a transmitting mobile communication device 11, a receiving mobile communication device 12, the modulators/demodulators 13 and 14, and the network 15.

The transmitting mobile communication device 11 has a communication port 111, a first command sending module 112 and a data sending module 113. While the testing staff starts the testing, the first command sending module 112 sends an attention command to the modulator/demodulator (modem) 13 through the communication port 111. When the modulator/demodulator (modem) 13 receives the attention command AT1, a connection alarm command MAT1 is sent back to the first command sending module 112 to notify that the linking of the transmitting mobile communication device 11 has been established. The linking means that the transmitting mobile communication device 11 is linked to the modulator/demodulator (modem) 13.

After the transmitting mobile communication device 11 confirms that the linking has been established through the connection command sent back from the modulator/demodulator (modem) 13, the data sending module 113 sends testing data D1 to the modulator/demodulator (modem) 13 through the communication port 111. The modulator/demodulator (modem) 13 then sends testing data D1 to another modulator/demodulator (modem) 14 through the network 15, and the testing data is further sent to the receiving mobile communication device 12. Thus, the testing staff could observe the communication quality between the transmitting mobile communication device 11 and the receiving mobile communication device 12.

However, the foregoing testing system must connect the modulators/demodulators 13 and 14 through the network 15 so as to transmit testing data D1. If the coverage rate of the network 15 in the environment where testing staff stays at is not good enough or the network communication quality is not well, the testing result obtained by testing staff during the testing process may be useless or the testing staff may be unable to perform the linking test.

### SUMMARY

A primary object of the present invention is to provide a simulation testing system and a simulation testing method thereof; and more particularly to a simulation testing system for a mobile communication apparatus and a simulation testing method thereof. The object of the simulation testing system for a mobile communication apparatus and a simulation testing method thereof is to dismiss the requirement of network connection; thus, a first mobile communication device is connected with a second mobile communication device to conduct the simulation testing.

To achieve the above and other objects, a simulation testing system for a mobile communication apparatus according to the present invention comprises a first mobile communication device and a second mobile communication device. The first mobile communication device comprises a first command processing module and a data processing module. The first command processing module sends an attention command. The data processing module has testing data. The second mobile communication device is electrically connected to the first mobile communication device and comprises a second command processing module. The second command processing module has a simulation unit for receiving the attention command and simulating a modulator/demodulator (modem) to transmit a simulation connection command. After the first mobile communication device receives the simulation connection command, the data processing module sends the testing data to the second mobile communication device.

In one preferred embodiment of the present invention, the first mobile communication device further comprises a first communication port, and the first communication port is electrically connected to the first command processing module and the data processing module, and connected to the second mobile communication device to transmit and receive the attention command, the testing data and the simulation connection command. Moreover, the first communication port is one of an infrared port, a Bluetooth port, and a universal asynchronous transceiver (UART).

In another preferred embodiment of the present invention, the testing data is one of the video data and the video communication data.

In another preferred embodiment of the present invention, the second mobile communication device further comprises a broadcasting module for receiving and broadcasting the testing data.

A simulation testing method of the present invention is further disclosed, which is applicable to a simulation testing system for a mobile communication apparatus. The simulation testing method comprises the following steps of: connecting the first mobile communication device and the second mobile communication device; generating an attention command through the first mobile communication device; sending the attention command to the second mobile communication device through the first mobile communication device; after the second mobile communication device receives the attention command, a simulation unit of the second mobile communication device simulating a modulator/demodulator (modem) and sending a simulation connection command to the first mobile communication device; and after the first mobile communication device receives the simulation connection command, the first mobile communication device sending testing data to the second mobile communication device.

The simulation testing system for a mobile communication apparatus and the simulation testing method thereof according to the present invention have the following advantages:

Since the first mobile communication device and the second mobile communication device are directly connected, the simulation unit of the second mobile communication device sends simulation connection command to the first mobile communication device. Then, the first mobile communication device assess that the link with the second mobile communication device is connected, and starts to send testing data to the second mobile communication device. Compared with previous testing system of a mobile communication apparatus, the simulation testing system for a mobile communication apparatus of the present invention does not need a network. Therefore, the development of video phone would be more smoothly than before.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a schematic diagram for a first command sending module sending an attention command.

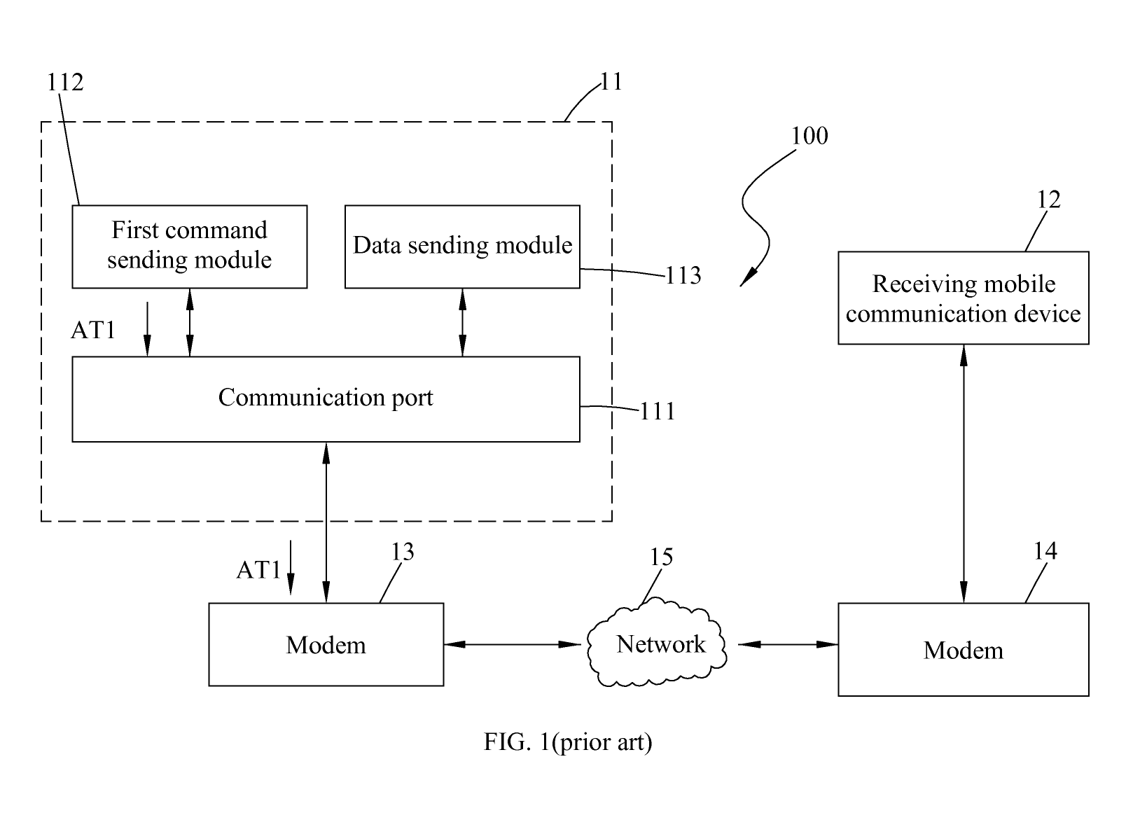

FIG. 2 is a schematic diagram for a modulator/demodulator (modem) sending a connection command.

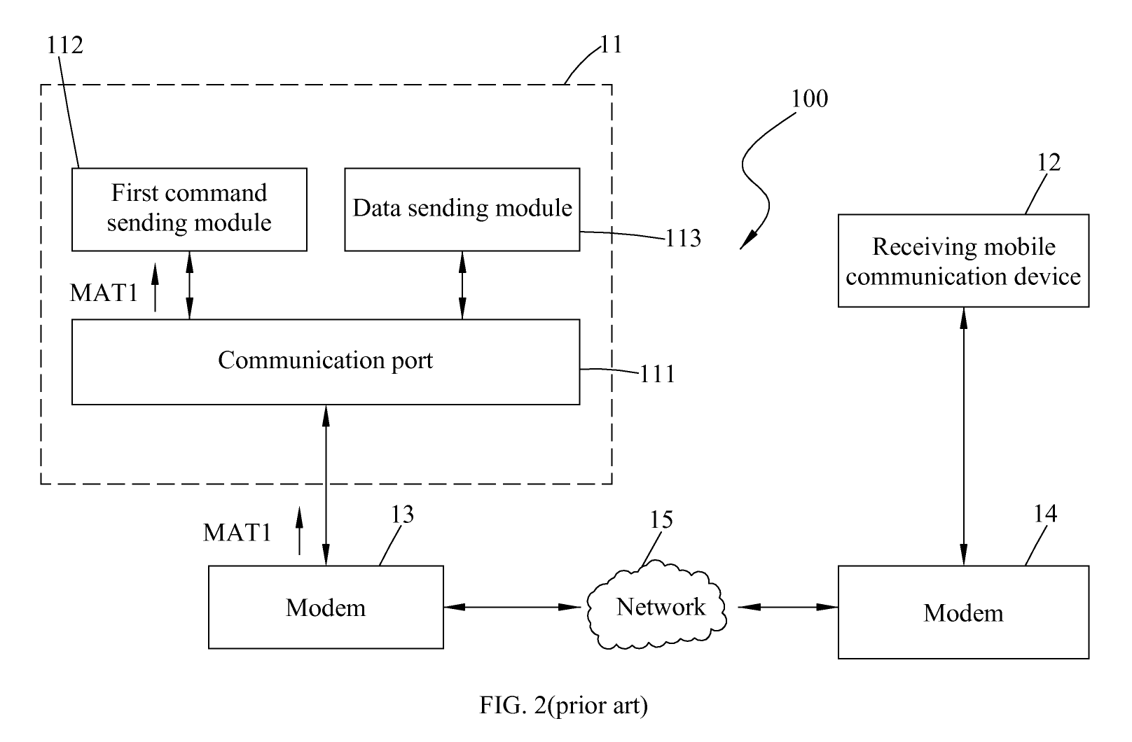

FIG. 3 is a schematic diagram for a data sending module sending testing data to a receiving mobile communication device via networks.

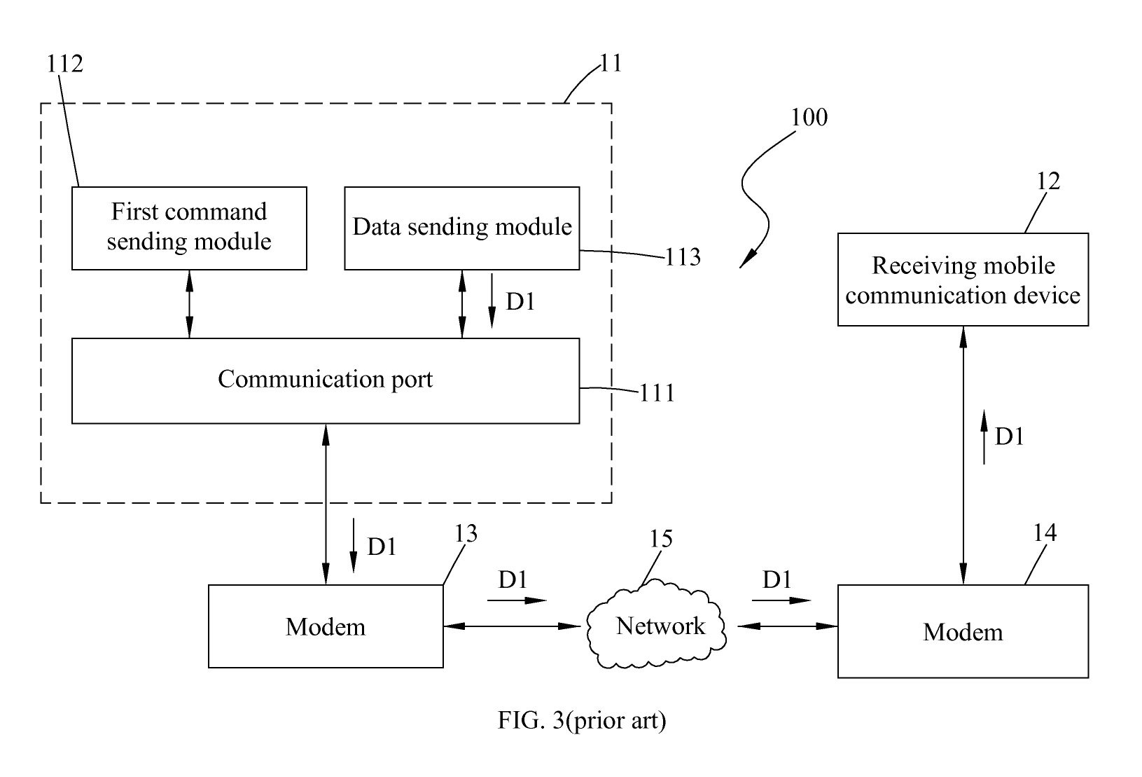

FIG. 4 is a block diagram showing the first command processing module sending an attention command according to an embodiment of the present invention.

FIG. 5 is a block diagram showing the simulation unit transmitting a simulation connection command according to an embodiment of the present invention.

FIG. 6 is a block diagram showing the data processing module sending the testing data to the second mobile communication device according to an embodiment of the present invention.

FIG. 7 is a flowchart of the simulation testing method according to the present invention.

### DETAILED DESCRIPTION

A primary object of the present invention is to provide a simulation testing system and a simulation testing method thereof; and more particularly to a simulation testing system for a mobile communication apparatus and a simulation testing method thereof. The present invention will now be described with some preferred embodiments thereof and with reference to the accompanying drawings. For the purpose of easy to understand, elements that are the same in the preferred embodiments are denoted by the same reference numerals.

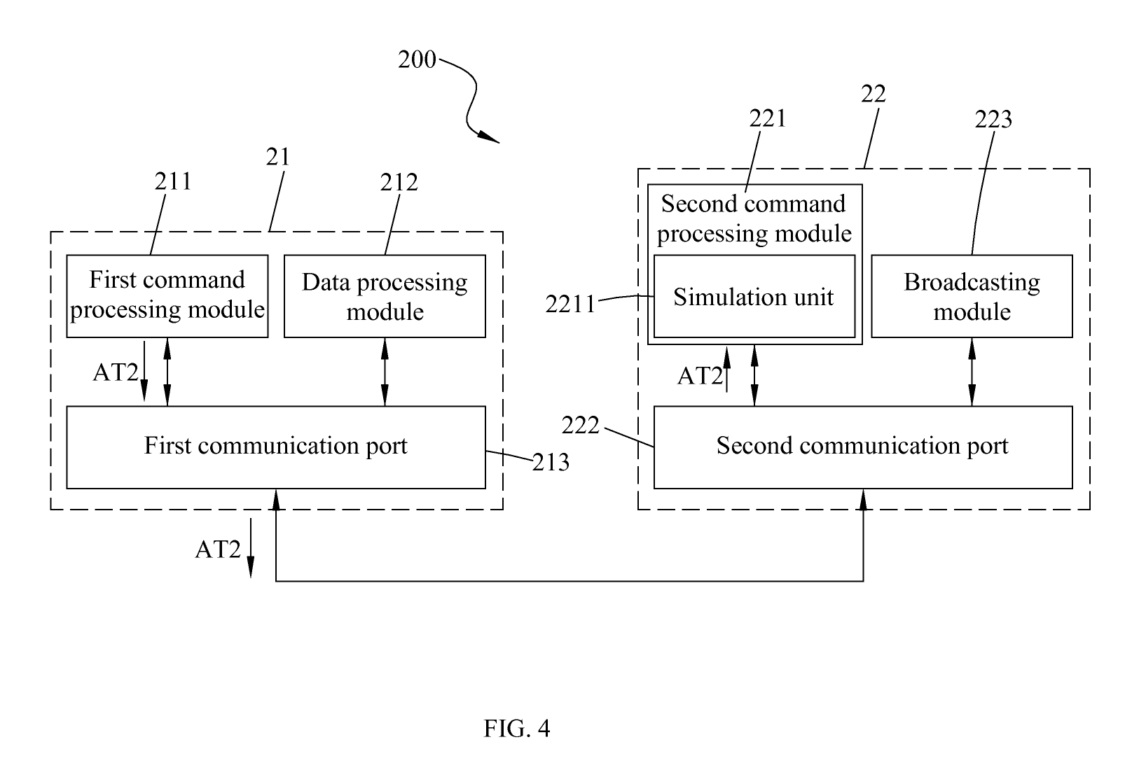

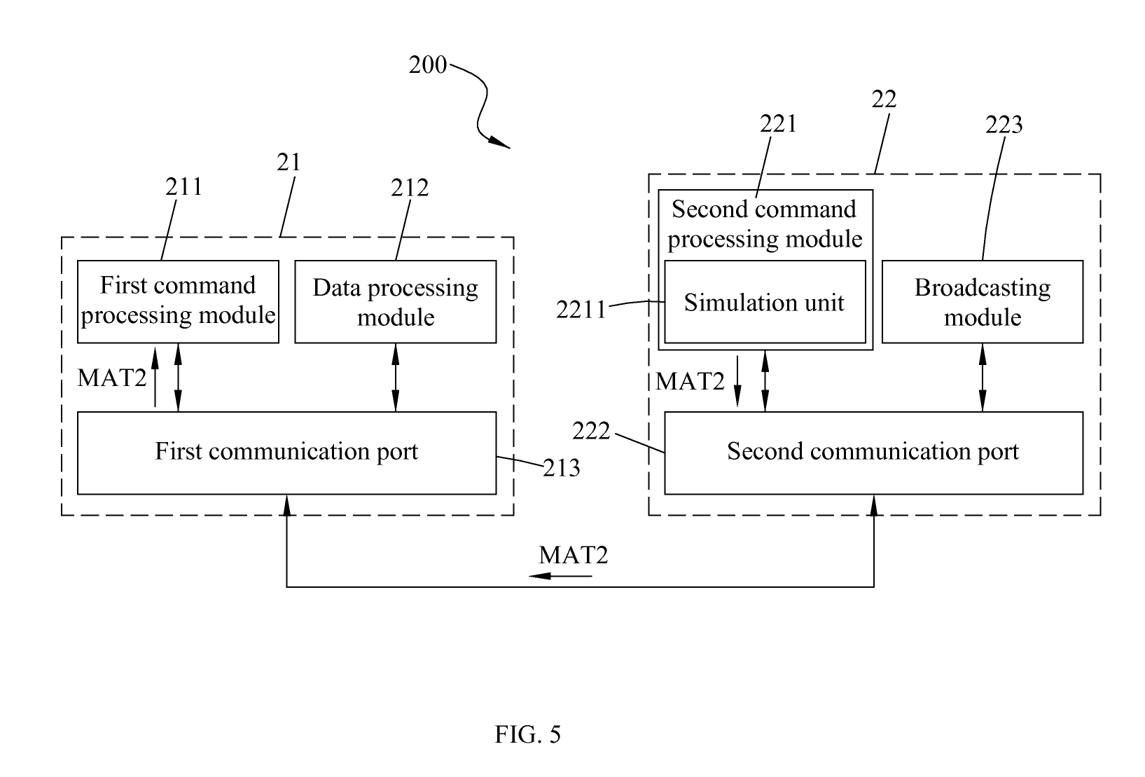

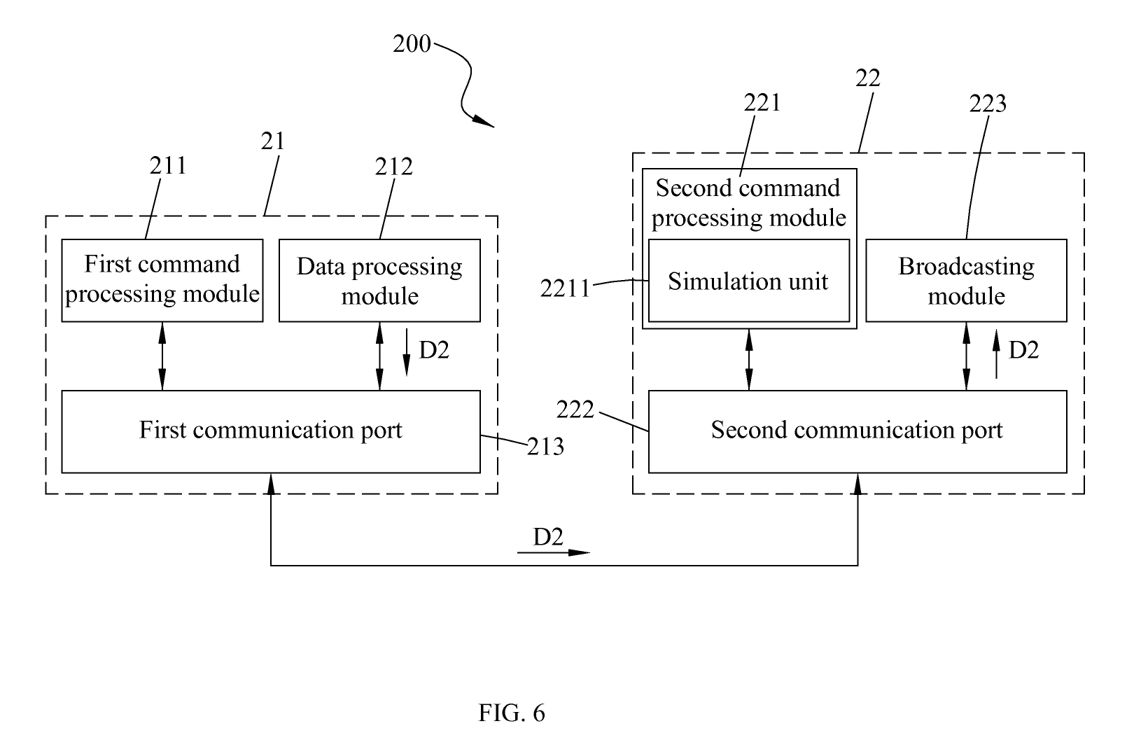

Please refer to FIG. 4, FIG. 5 and FIG. 6. FIG. 4 is a block diagram showing the first command processing module sending an attention command according to an embodiment of the present invention. FIG. 5 is a block diagram showing the simulation unit transmitting a simulation connection command according to an embodiment of the present invention. FIG. 6 is a block diagram showing the data processing module sending the testing data to the second mobile communication device according to an embodiment of the present invention. The simulation testing system 200 for a mobile communication apparatus of the present invention comprises a first mobile communication device 21 and a second mobile communication device 22.

The first mobile communication device 21 comprises a first command processing module 211 and a data processing module 212. The first command processing module 211 sends an attention command AT2. The data processing module 212 has testing data D2 (illustrated in FIG. 6). Moreover, the testing data D2 may be a video data or the video communication data generated by the first mobile communication device 21 during communication.

The second mobile communication device 22 is electrically connected to the first mobile communication device 21. The second mobile communication device 22 comprises a second command processing module 221. The second command processing module 221 has a simulation unit 2211 for receiving the attention command AT2 and simulating a modulator/demodulator (modem) to transmit a simulation connection command MAT2 (illustrated in FIG. 5).

After the first mobile communication device 21 receives the simulation connection command MAT2, the data processing module 212 sends the testing data D2 to the second mobile communication device 22. In addition, the second mobile communication device 22 further comprises a broadcasting module 223 for receiving and broadcasting the testing data D2. Then, the testing staff could observe the communication quality during the communication process.

The first mobile communication device 21 further comprises a first communication port 213. The first communication port 213 is electrically connected to the first command processing module 211 and the data processing module 212, and connected to the second mobile communication device 22 to transmit and receive the attention command AT2, the testing data D2 and the simulation connection command MAT2. Moreover, the first communication port 213 may be an infrared port, a Bluetooth port or a universal asynchronous transceiver (UART).

Also, the second mobile communication device 22 further comprises a second communication port 222. The second communication port 222 is electrically connected to the second command processing module 221 and connected to the first mobile communication device 21 to receive and transmit the attention command AT2, the testing data D2 and the simulation connection command MAT2.

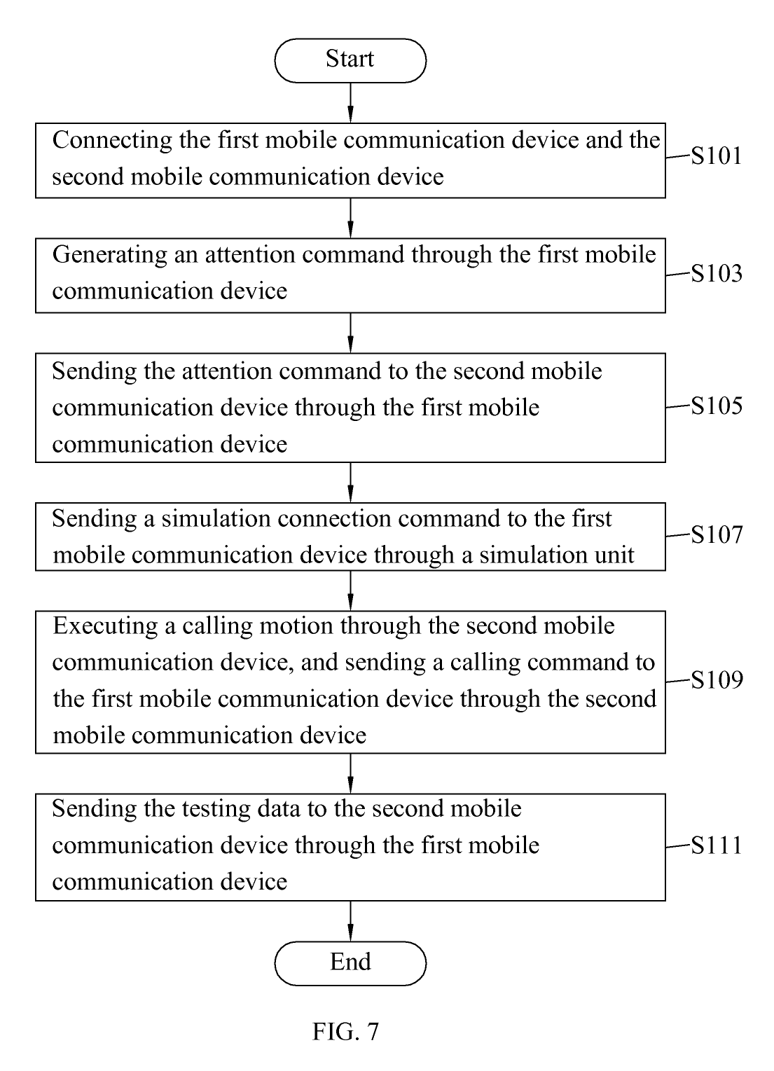

A simulation testing method of the present invention is further disclosed, which is applicable to the abovementioned simulation testing system 200. Please refer to FIG. 7 which is a flowchart of the simulation testing method according to the present invention. As shown, the flowchart of the simulation testing method comprises the following steps.

In step S101: the first mobile communication device 21 is electronically connected with the second mobile communication device 22.

In step S103: the first mobile communication device 21 generates an attention command.

In step S105: the first mobile communication device 21 sends the attention command AT2 to the second mobile communication device 22.

In step S107: after the second mobile communication device 22 receives the attention command AT2, a simulation unit 2211 of the second mobile communication device 22 simulating a modulator/demodulator (modem) and sending a simulation connection command MAT2 to the first mobile communication device 21. In addition, a ring bell of the second mobile communication device 22 is used to remind the testing staff to perform a calling motion.

In step S109: the testing staff performs a calling motion through the second mobile communication device 22, and the second mobile communication device 22 sends a calling command (figure not showing) to the first mobile communication device 21.

In step S111: after the first mobile communication device 21 receives the simulation connection command MAT2 and the calling command, the first mobile communication device 21 sends testing data D2 to the second mobile communication device 22. In addition, the second mobile communication device 22 further comprises a broadcasting module 223 for receiving and broadcasting the testing data D2. Next, the testing staff could observe the communication quality during the communication process.

While the testing staff hangs up the first mobile communication device 21, the first mobile communication device 21 transmits a hanging up command (figure not showing) to the second mobile communication device 22. The second mobile communication device 22 responds a received command (not shown in the figure) to the first mobile communication device 21 according to the hanging up command. While the first mobile communication device 21 receives the received command, the simulation testing system 200 determines that the communication is finished and then terminates the video calling.

In summary, since the first mobile communication device 21 and the second mobile communication device 22 of the simulation testing system 200 are connected to each other, the simulation unit 2211 of the second mobile communication device 22 sends simulation connection command MAT2 to the first mobile communication device 21. Thus, the first mobile communication device 21 determines that the link with the second mobile communication device 22 is connected, and starts to send testing data D2 to the second mobile communication device 22. The simulation testing system 200 for a mobile communication apparatus of the present invention does not need a network. Therefore, without the limitation of quality and coverage rate of internet, the simulation testing of video phone would be more smoothly than before. In addition, the simulation testing system 200 does not need to modify the hardware of the first mobile communication device 21 and the second mobile communication device 22. Hence, compared with previous testing system of a mobile communication apparatus, the system and method of the present invention do not need a lot of additional cost for research and development.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A simulation testing system for a mobile communication apparatus, comprising:
a first mobile communication device, comprising:
a first command processing module for sending an attention command; and
a data processing module having testing data; and
a second mobile communication device electrically connected to the first mobile communication device and comprising:
a second command processing module having a simulation unit for receiving the attention command and simulating a modulator/demodulator (modem) to transmit a simulation connection command;
wherein the data processing module sends the testing data to the second mobile communication device after the first mobile communication device receives the simulation connection command.

2. The simulation testing system for the mobile communication apparatus as recited in claim 1, wherein the first mobile communication device further comprises a first communication port, and the first communication port is electrically connected to the first command processing module and the data processing module, and connected to the second mobile communication device to transmit and receive the attention command, the testing data and the simulation connection command.

3. The simulation testing system for the mobile communication apparatus as recited in claim 2, wherein the first communication port is one of an infrared port, a Bluetooth port and a universal asynchronous transceiver (UART).

4. The simulation testing system for the mobile communication apparatus as recited in claim 1, wherein the second mobile communication device further comprises a second communication port, and the second communication port is electrically connected to the second command processing module and connected to the first mobile communication device to receive and transmit the attention command, the testing data and the simulation connection command.

5. The simulation testing system for the mobile communication apparatus as recited in claim 1, wherein the testing data is one of the video data and the video communication data.

6. The simulation testing system for the mobile communication apparatus as recited in claim 1, wherein the second mobile communication device further comprises a broadcasting module for receiving and broadcasting the testing data.

7. A simulation testing method for a mobile communication system having a first mobile communication device and a second mobile communication device, the simulation testing method comprising the following steps:
(a) connecting the first mobile communication device and the second mobile communication device;
(b) generating an attention command through the first mobile communication device;
(c) sending the attention command to the second mobile communication device through the first mobile communication device;
(d) after the second mobile communication device receives the attention command, a simulation unit of the second mobile communication device simulating a modulator/demodulator (modem) and sending a simulation connection command to the first mobile communication device; and
(e) after the first mobile communication device receives the simulation connection command, the first mobile communication device sending testing data to the second mobile communication device.

8. The simulation testing method for the mobile communication system as recited in claim 7, after performing the step (d), further comprising a step (d-1) of executing a calling motion through the second mobile communication device, wherein the second mobile communication device sends a calling command to the first mobile communication device.

9. The simulation testing method for the mobile communication system as recited in claim 8, wherein the step (e) further comprises a step of: sending the testing data to the second mobile communication device through the first mobile communication device after the first mobile communication device receives the simulation connection command and the calling command.

10. The simulation testing method for the mobile communication system as recited in claim 7, further comprising a step (f) of utilizing a data broadcasting module of the second mobile communication device to receive and broadcast the testing data after executing the step (e).
